(19) United States
(12) Patent Application Publication
(10) Pub. No.: US 2020/0027184 A1
(43) Pub. Date: Jan. 23, 2020

(54) METHODS AND APPARATUS FOR PROVIDING TRANSPORTATION SERVICES TO CUSTOMERS

(71) Applicant: Ford Motor Company, Dearborn, MI (US)

(72) Inventor: Kenneth James Miller, Canton, MI (US)

(21) Appl. No.: 16/469,191

(22) PCT Filed: Dec. 14, 2016
(86) PCT No.: PCT/US16/66605

§ 371 Date: Jun. 13, 2019

(51) Int. Cl. G06Q 50/30; G06N 20/00; G06Q 10/06; G06F 17/27; G10L 15/22; G10L 15/18

(52) U.S. Cl. CPC G06Q 50/30; G06N 20/00; G06Q 10/063112; G06F 3/0482; G10L 15/22; G10L 15/18; G06F 17/2765

(57) ABSTRACT

Methods and apparatus to provide transportation related services to customers are disclosed. A disclosed apparatus includes a request analyzer to extract, from a natural language phrase of a text or audio provided by a person, requirements associated with a driving service, the person to receive the driving service. A processor compares the requirements to first credentials associated with service providers to provide the driving service. The first credentials are stored in a database. The processor identifies, based on the comparison, one or more of the requirements that do not correspond to the first credentials. A communicator is to request from the service providers, first information relating to the identified one or more requirements and receive second information in response to the request for the first information. The second information includes second credentials relating to the identified one or more requirements. The database is then updated with the first and second information.

### FIELD OF THE DISCLOSURE

This disclosure relates generally to ride-hailing systems and, more particularly, methods and apparatus for providing transportation services to customers.

### BACKGROUND

Ride-hailing systems (e.g., Uber®, Lyft®, etc.) are typically utilized to enable customers to receive temporary transportation services from drivers registered with the system. Customers may interact with a ride-hailing system via an electronic device (e.g., a smartphone, a computer, etc.) and/or a graphical user interface (GUI) to input and provide requests for transportation services, such as taxiing the customers to a location. The system then analyzes and filters qualifications (e.g., locations of the drivers, vehicle types, etc.) stored in a system database and associated with the drivers in accordance with the requests. A list may be generated that includes the drivers having qualifications that match a request. The list may be sent electronically to the electronic device of the customer making the request to enable the customer to view the list and select a desired driver to perform or provide the service. After a selection is made, the system electronically sends booking information (e.g., locations of the customers and/or drivers, contact information of the customers and/or drivers, etc.) to electronic devices associated with the customer and the driver to enable the driver to provide the service and the customer to receive the service.

### SUMMARY

An example apparatus includes a request analyzer to extract, from a natural language phrase of text or audio provided by a person, requirements associated with a driving service, the person to receive the driving service. The request analyzer is to further compare the requirements to first credentials associated with service providers to provide the driving service. The first credentials are stored in a database. The request analyzer is to further identify, based on the comparison, one or more of the requirements that do not correspond to the first credentials. A communicator is to request from the service providers, first information relating to the identified one or more requirements and receive second information in response to the request for the first information. The second information includes second credentials relating to the identified one or more requirements. The communicator is to further update the database with the first or second information.

An example method includes extracting, from a natural language phrase of text or audio provided by service providers, first credentials associated with driving services, the service providers to perform the driving services. A processor compares the first credentials with first requirements stored in a database, the requirements associated with the driving services. The processor identifies, based on the comparison, a second requirement that does not correspond to the first requirements. First information relating to the second requirement is requested from the service providers. Second information is received in response to the request for the first information, the second information including second credentials relating to the second requirement. The database is updated with the first or second information.

An example tangible machine-readable medium includes instructions, which when executed, cause a processor to extract, from a natural language phrase of text or audio provided by a person, requirements associated with a driving service, the person to receive the driving service. The processor compares the requirements to first credentials associated with service providers to provide the driving service. The first credentials are stored in a database and the processor identifies, based on the comparison, one or more of the requirements that do not correspond to the first credentials. The processor requests from the service providers, first information relating to the identified one or more requirements and receives second information in response to the request for the first information. The second information includes second credentials relating to the identified one or more requirements. The processor then updates the database with the first or second information.

### BRIEF DESCRIPTION OF THE DRAWINGS

FIG. 1A is a schematic illustration of an example apparatus including example electronic devices for interacting with the example apparatus in accordance with the teachings disclosed herein.

FIG. 1B illustrates a block diagram of an example application associated with the example apparatus shown in FIG. 1A

FIGS. 2A and 2B illustrate example displays of an example graphical user interface associated with the example electronic devices shown in FIG. 1A

FIGS. 3A and 3B illustrate additional example displays of an example graphical user interface associated with the example electronic devices shown in FIG. 1A

FIG. 4-6 illustrate additional example displays of example graphical user interfaces associated with the example electronic devices shown in FIG. 1A.

FIG. 7 is a flow diagram of an example method that may be executed to implement the example apparatus shown in FIG. 1A.

FIG. 8 is a flow diagram of another example method that may be executed to implement the example apparatus shown in FIG. 1A.

FIG. 9 is a block diagram of an example processor platform that may be used to carry out the example methods of FIGS. 7 and 8 and/or, more generally, to implement the example apparatus shown in FIG. 1A.

The figures disclosed herein are not to scale. Wherever possible, the same reference numbers will be used throughout the drawings and accompanying written descriptions to refer to the same or like parts.

### DETAILED DESCRIPTION

Ride-sharing or Ride-hailing systems (e.g., Uber®, Lyft®, etc.) are typically utilized in urban areas to enable customers (e.g., persons) to receive temporary transportation services, such as taxiing a person to a location. These systems have databases containing service provider information associated with registered service providers (e.g., drivers, vehicles, vehicle owners etc.). Service provider information is generally provided by the service providers during an initial registration with a ride-hailing system via a first graphical user interface (GUI) associated with electronic devices (e.g., smartphones, computers, etc.). The service provider information typically includes common characteristics or qualifications, such as vehicle types, locations of vehicles, etc., of the service providers that correspond to the services.

Customers may input requests for transportation related services, such as taxis to locations, to the system by interacting with the electronic devices via a second GUI. The requests typically include common requirements, such as requiring a vehicle to travel to a location and/or requiring a driver to drive the vehicle to the location. To facilitate selection of the requirements when inputting or providing requests, the second GUI provides pre-defined fields (e.g., text boxes, drop-down menus, etc.) including the above-described common requirements to facilitate selections of the common requirements. Additionally, service providers may select from similar pre-defined fields including commonly provided qualifications, such as vehicle types or locations, via the first GUI.

After a request is provided, the system analyzes and filters the qualifications to identify service providers having qualifications that match the requirements of the request. A list including the identified service providers is then generated and sent electronically or provided to the requesting customer via their electronic device. The customer views the list and selects one of the identified service providers via the first GUI. After a selection is made, booking information (e.g., location, time, date, contact information, etc.) is generated and sent electronically or provided to the selected service providers and the customer to enable the selected service provider to provide the service and/or, more generally, to enable the requesting customer to receive the service.

Often, the above-described systems constrain or limit requests provided by customers. For example, the pre-defined fields of requirements may not correspond to certain requirements desired by the customers. Specifically, customers may have detailed and/or unique requirements associated with the requests, such as requirements that are not included in the pre-defined fields of requirements. Additionally, the qualifications of the service providers stored within the system database may not match and/or correspond to these types of requirements. As a result, the above-described systems may fail to provide customers with certain services.

The methods and apparatus described herein provide customers with transportation services that would otherwise not have been provided. More specifically, customer text or audio associated with transportation related services is received and/or analyzed to extract requirements (e.g., unique requirements) associated with the services. In some examples, the text or audio may include natural language phrases (e.g., textual information, audio information, etc.) provided by the customers. In such examples, the extracted requirements may be contained or embedded within the natural language phrases.

In other examples, text or audio associated with service providers is received and analyzed to extract credentials of the service providers. The extracted credentials may be compared to requirements stored in the database to identify credentials that do not correspond to the stored requirements (e.g., the stored requirements do not mention the identified credentials). In such examples, pattern recognition methods or techniques may be implemented to determine and/or extract, based on the identified credentials, requirements associated with transportation related services that may not be stored in the database.

The above-described extracted requirements may not correspond to, in some examples, the credentials of service providers stored in the system database. In some examples, the extracted requirements are compared to credentials (e.g., characteristics, attributes, certifications, etc.) of the service providers stored in the system database to identify requirements that do not correspond to at least some of the credentials (e.g., the identified requirements are not included or mentioned in the credentials). In such examples, first information is generated (e.g., text or audio) and may be sent electronically to and/or requested electronically from service providers that may have the non-corresponding credentials. In some examples, the first information may be sent electronically to additional or all service providers in response to determining, for example, a particular number (e.g., a number above a threshold number) of the service providers having credentials that do not correspond to the extracted requirements. This first information corresponds and/or relates to the identified requirements (e.g., questions regarding the identified requirements). In response to sending and/or requesting the first information, second information associated with and/or corresponding to the service providers is received. This second information may be entered by the service providers via the first GUI and may include additional credentials of the service providers that correspond to the identified requirements. In some examples, the credentials and/or the additional credentials are extracted from natural language phrases.

Additionally or alternatively, the customer text or audio and/or the second information are received from a resource (e.g., a database associated with Craigslist® or LinkedIn®, a web-based application, big data sources (e.g., literatures, articles, social media), etc.) that is not associated a ride-hailing system. In some examples, the second information includes crowd-sourced information (e.g., crowd-sourced ratings). In other examples, customer service requests and/or requirements associated with the requests may be received from one or more of the resources. In any case, after generating the first information and/or receiving the second information, the system database is updated with the first and/or second information. In some examples, dynamic selection fields that may be displayed via the first and second GUIs are updated with the extracted requirements and/or the additional credentials.

Interactive reports are generated and provided to the customers and/or the service providers to facilitate decisions and/or selections. These interactive reports may include certain information of the requests and/or service provider information such as, for example, certain requirements, certain credentials, profile information, contact information, etc. More generally, these interactive reports include the above-described extracted requirements and/or additional credentials that may be necessary or required to enable selected service providers to perform or provide the services.

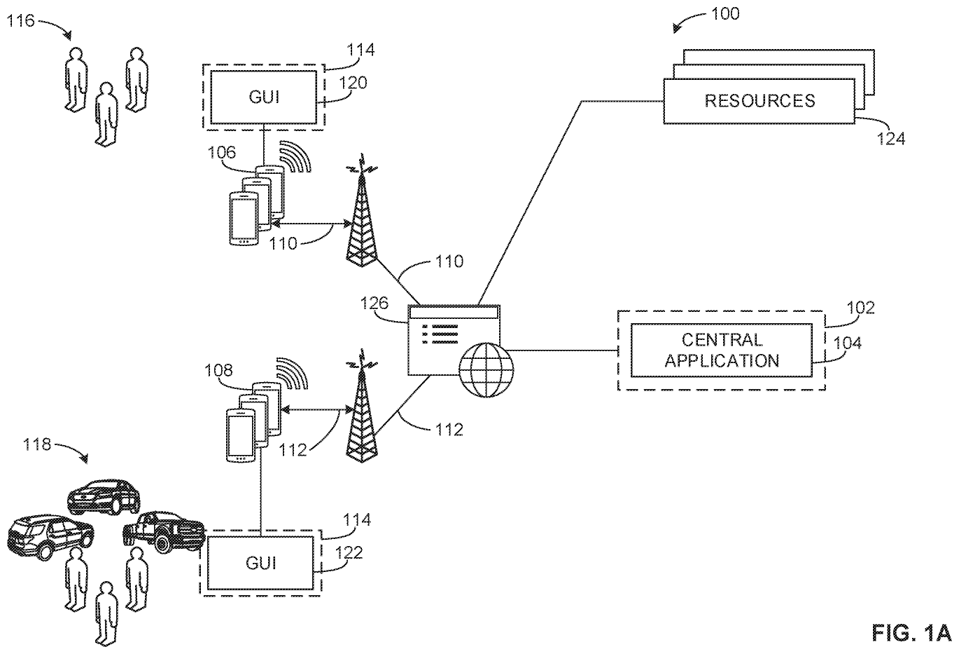

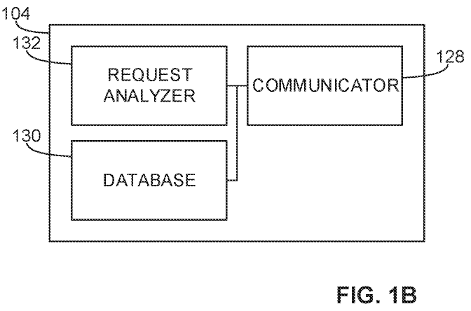

Turning in detail to FIG. 1A, an example system 100 is illustrated in accordance with the teachings of this disclosure. The example system 100 includes a first processor 102 that executes a central application 104. In this example, the first processor 102 is in wireless communication with electronic devices (e.g., smartphones, computers, tablets, etc.) 106, 108, as represented by respective communication links 110, 112. Each of the electronic devices 106, 108 includes a second processor 114. The uppermost (in the orientation of FIG. 1A) electronic devices 106 are associated with customers (e.g., persons, business entities, etc.) 116 and the lowermost electronic devices 108 are associated with service providers (e.g., drivers, vehicles, owners of vehicles, etc.) 118. For example, the customers 116 and/or service providers 118 interact with the electronic devices 106, 108, respectively. The above-described customers 116 and/or service providers 118 may be generally referred to herein as “users.”

The example system 100 includes first and second example graphical user interfaces (GUIs) 120, 122 that may be associated with the electronic devices 106, 108, respectively. The users provide inputs to the electronic devices 106, 108 to enter and/or provide data/information to the central application 104 via the first and second GUIs 120, 122 such as request information, service provider information, settings information, selections and/or, more generally, data/information associated with the users. Additionally or alternatively, in some examples, this data/information is provided to the central application 104 from one or more resources (e.g., a processor and/or applications associated with Craigslist® or LinkedIn®, other web-based applications, big data sources, etc.) 124. In such examples, the central application 104 receives at least some of the data/information via other communication networks (e.g., the Internet) 126 associated with the one or more resources 124.

In some examples, the customers 116 provide text or audio including request information associated with commercial driving and/or transportation related services, such as taxis, deliveries, vehicle rentals, etc., to the central application 104 via the first example GUI 120 of the electronic devices 106. This request information is referred to herein as service requests. For example, a person may provide and/or initiate a service request including a vehicle (e.g., a van, a truck, an autonomous car, etc.) to transport commercial goods to a location and, additionally, a driver to operate the vehicle and deliver the commercial goods. In some examples, the request information includes requirements, such as a specific type of vehicle (e.g., a van), a feature of the vehicle (e.g., a flatbed, a dimension of the flatbed, etc.), a certain license of the driver (e.g., a Government issued driver's license), a fare of the driver, etc.

In other examples, the service providers 118 provide text or audio including service provider information, such as characteristics, attributes, certifications, licenses, fares and/or, more generally, credentials of the service providers 118 that may correspond to the service requests and/or requirements of the service requests, to the central application 104 via the second example GUI 122 of the electronic devices 108. These credentials may be provided by respective service providers 118 or persons associated with the service providers 118 during an initial registration with the central application 104. Additionally or alternatively, in some examples, the service providers 118 enter and/or provide additional service provider information (e.g., unique service provider information), such as, for example, credentials that were not provided during the initial registration, to the central application 104 via the second example GUI 122 of the electronic devices 108.

In other examples, the users receive and/or interact with certain data/information received from the central application 104 via the first and second example GUIs 120, 122 of the electronic devices 106, 108. For example, the central application 104 may generate interactive reports (e.g., customer reports, service provider reports and/or booking reports) including at least some of the provided data/information. In such examples, the reports facilitate decisions and/or selections (e.g., a selection of suitable service providers, a selection of a service request, etc.) by the users. For example, the data/information included within customer reports is processed by the central application 104 to identify suitable service providers 116. More generally, the users receive necessary processed data/information from the central application 104 to enable the customers 116 to receive service requests from one or more of the service providers 118 and/or to enable one or more of the service providers 118 to perform and/or provide the service requests.

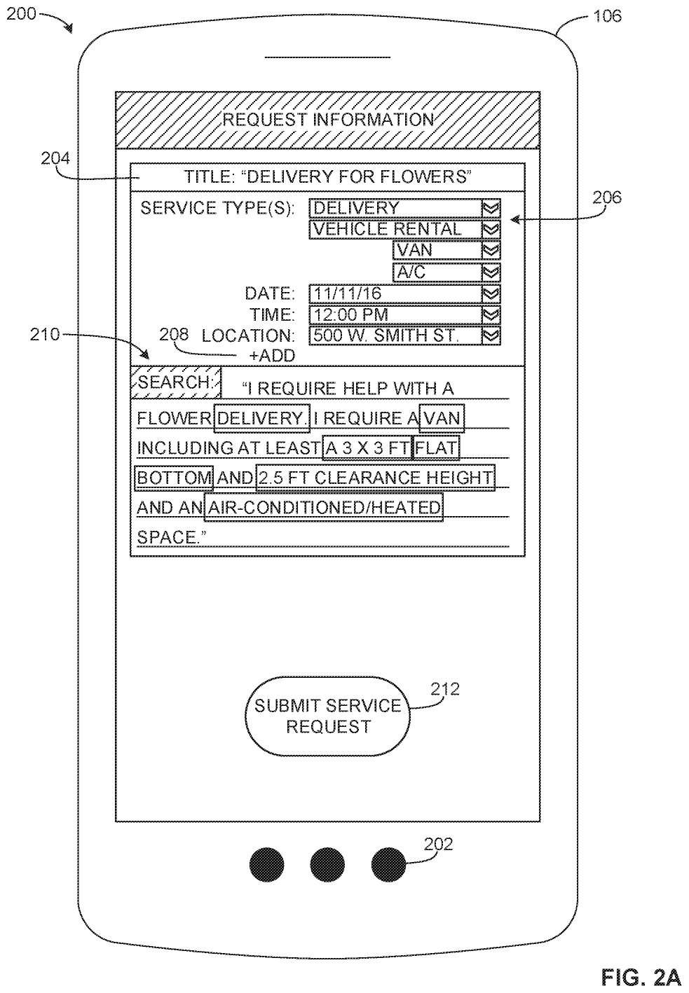

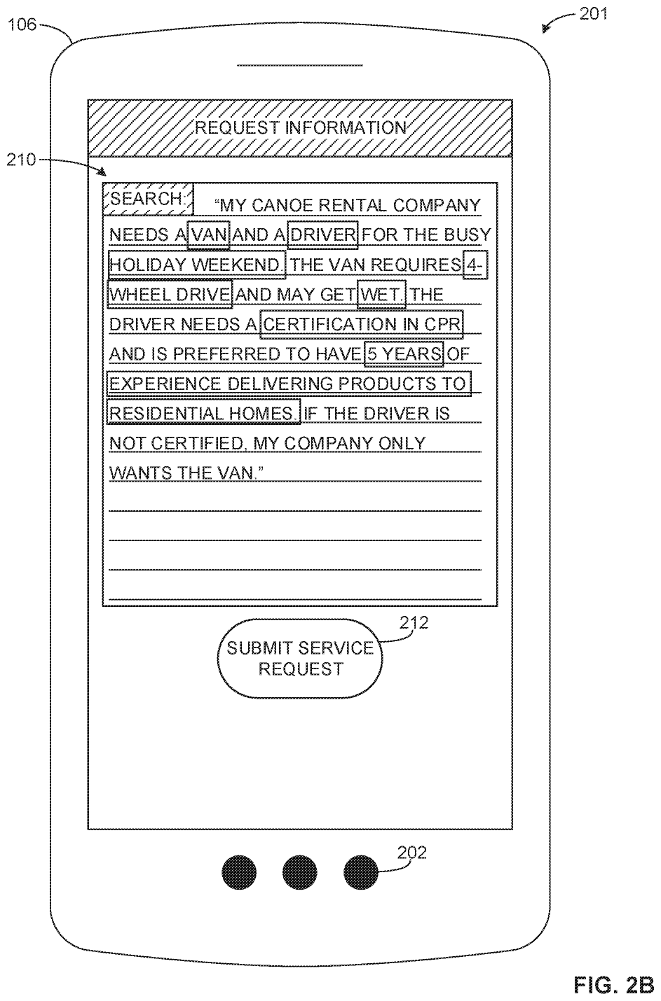

The above-described data/information and first and second example GUIs 120, 122 of the electronic devices 106, 108 are explained in greater detail below in connection with FIGS. 2A, 2B, 3A, 3B and 4-6.

FIG. 1B illustrates a block diagram of the central application 104 of the example system 100 shown in FIG. 1A. The central application 104 includes a communicator 128 that receives incoming data/information (e.g., via wireless communication, the Internet, etc.) to encode, analyze, filter and/or pre-process data/information for a database 130 and/or a request analyzer 132. In such examples, the communicator 128 stores the pre-processed data/information in the database 130. In other examples, the communicator 128 generates and/or provides information such as interactive reports, dynamic selection fields and/or natural language phrases that may be displayed via the first and second GUIs 120, 122. Information generated and/or provided by the communicator 128 may include at least some of the data/information stored in the database 130 to facilitate decisions and/or selections of the users. In some examples, the communicator 128 organizes or formats the reports based on, for example, comparisons performed by the request analyzer 132, which is explained in greater detail below, and/or settings information provided by the customers 116. In other examples, natural language phrases generated (e.g., text or audio) by the communicator 128 may include questions relating to specific requirements of service requests.

The request analyzer 132 of the central application 104 analyzes and/or processes the data/information stored in the database 130 to determine and/or identify suitable candidate service providers 118 to perform or provide one or more of the service requests. To determine or identify whether service providers 118 are suitable, the request analyzer 132 may consider comparisons of certain data/information stored in the database 130. For example, the request analyzer 132 may compare credentials of the service providers 118 with requirements of the service requests. In such examples, the requirements may include criteria such as logical operators or values (e.g., a Boolean value, a numerical value) that correspond to the credentials. In some examples, the requirements may include a rank to adjust results of the comparisons. For example, the customers 116 may desire a particular requirement more than other requirements and may enter or provide a rank for the particular requirement when entering or providing the service requests. Additionally or alternatively, in some examples, the request analyzer 132 identifies and/or extracts one or more requirements that do not correspond to credentials stored in the database 130. These identified and/or extracted one or more requirements may not be stored in the database 130 and/or may not correspond to requirements of service requests stored in the database 130. In such examples, the communicator 128 generates first information (e.g., text or audio) based on the one or more identified and/or extracted requirements, such as questions related to and/or including the identified and/or extracted requirements. In some examples, this first information may have a structure that is determined by the communicator 120 and based on qualities or characteristics of the one or more identified requirements.

In some examples, the request analyzer 132 processes and/or analyzes the data/information that may be stored in the database 130 to identify and/or extract requirements of the service requests and/or credentials of the service providers 118 that may be contained or embedded within natural language phrases provided by the users. In such examples, the request analyzer 132 may implement fuzzy search and/or fuzzy logic methods and/or techniques to identify and/or extract the requirements and/or credentials. In some examples, the request analyzer 132 may implement pattern recognition methods and/or techniques (e.g., supervised classification, unsupervised classification, etc.) and/or other methods to identify and/or extract requirements that do not correspond to credentials stored in the database 130. In other examples, the above described fuzzy search logic and/or pattern recognition methods and/or techniques are advantageously used to determine a relevancy and/or correlation of the requirements with the credentials.

While an example manner of implementing the system 100 is illustrated in FIGS. 1A and 1B, one or more of the elements, processes and/or devices illustrated in FIGS. 1A and 1B may be combined, divided, re-arranged, omitted, eliminated and/or implemented in any other way. In the example of FIGS. 1A and 1B, the central application 104 is depicted as a web-based application that is hosted by the processor 102 (e.g., a server). However, any other system architecture may be used. For example, some or all of the operations of the central application 104 may be resident in the electronic devices 106, 108. Further, the example first processor 102, the electronic devices 106, 108, the second processor 114 of each of the electronic devices 106, 108, the central application 104 (including the communicator 128, the database 130, the request analyzer 132) and/or, more generally, the example system 100 may be implemented by hardware, software, firmware and/or any combination of hardware, software and/or firmware. Thus, any of the example first processor 102, the electronic devices 106, 108, the second processor 114 of each of the electronic devices 106, 108, the central application 104 (including the communicator 128, the database 130, the request analyzer 132) and/or, more generally, the example system 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example first processor 102, the electronic devices 106, 108, the second processor 114 of each of the electronic devices 106, 108, the central application 104 (including the communicator 128, the database 130, the request analyzer 132) and/or, more generally, the example system 100 is/are hereby expressly defined to include a tangible computer readable storage device or storage disk such as a memory, a digital versatile disk (DVD), a compact disk (CD), a Blu-ray disk, etc. storing the software and/or firmware. Further still, the example system 100 of FIGS. 1A and 1B may include one or more elements, processes and/or devices in addition to, or instead of, those illustrated in FIGS. 1A and 1B, and/or may include more than one of any or all of the illustrated elements, processes and devices.

FIGS. 2A and 2B, illustrate example screens or graphic displays 200, 201 of the first example GUI 120 of the electronic devices 106 for entering or providing data/information to the central application 104. The example displays 200, 201 provide for inputs with respect to request information and/or requirements associated with service requests. The customers 116 can create or enter service requests by providing one or more inputs using the electronic devices 106, such as via typing and/or talking. In such examples, the electronic devices 106 include a keyboard (not shown) and/or a microphone 202 that may be integral with each of the electronic devices 106. For example, one of the customers 116 creates or enters request information such as a name or title 204 (FIG. 2A) for a particular driving service (e.g., “Delivery for Flowers”). In some examples, the example displays 200, 201 include dynamic selection fields (e.g., text boxes, drop-down menus) 206 of pre-determined requirements, such as service types, vehicle types, locations, times and dates, service costs, etc. to facilitate selection and/or entry of the requirements. Continuing with above example, a customer 116 may interact with the dynamic selection fields 206 to select the pre-determined requirements associated with the service request such as types of services (e.g., a delivery, a vehicle rental, etc.), a time (e.g., 12:00 pm), a vehicle type (e.g., a van including an air-conditioner and/or heater) and a location (e.g., 500 W. Smith St.). In some examples, a customer 116 may increase or decrease a number and/or content of the dynamic selection fields 206 by, for example, selecting text operators or buttons 208. In such examples, a customer 116 may view lists including pre-determined requirements and can select one or more of the pre-determined requirements to increase the number and/or content of the dynamic selection fields 206. In any case, a customer 116 can submit and/or provide the service request via a selection input such as, for example, selecting a submit button 212.

In some examples, the example displays 200, 201 include a search request field 210 to enable the customers 116 to create and/or enter request information and/or requirements via natural language phrases. For example, one of the customers 116 may enter request information via text or audio such as “I require help with a flower delivery. I require a van including at least a 3×3 ft. flat bottom, a 2.5 ft. clearance height and an air-conditioned/heated space. Additionally, the driver must have experience delivering products to residential homes.” In such examples, one or more requirements may be contained or embedded within the natural language phrases of the search requests such as, for example, a vehicle including a van, a flat-bottom or flatbed of the van, a dimension of the flatbed, etc.

In some examples, the customers 116 may create or enter service requests consisting only of natural language phrases, as shown in the example display 201 of FIG. 2B. For example, a customer 116 may enter request information via text or audio such as “My canoe rental company needs a van and a driver for the busy holiday weekend. The van requires 4-wheel drive and may get damp/wet. The driver needs a CPR certification and is preferred to have 5 years of experience delivering products to residential homes. If the driver is not certified, my company only requires the van.” In this example, the natural language phrases include one or more requirements associated with the service request such as renting a vehicle including a van and/or hiring a driver having a certain certifications or prior experience. Additionally or alternatively, in some examples, certain requirements may include a condition and/or a conditional statement (e.g., hiring the driver if the driver has a certification). In some examples, the condition and/or conditional statement may be satisfied by inferred requirements. For example, a conditional statement such as “I don't really need a big high-end vehicle” may be satisfied by an inferred requirement such as an economy car providing a low cost.

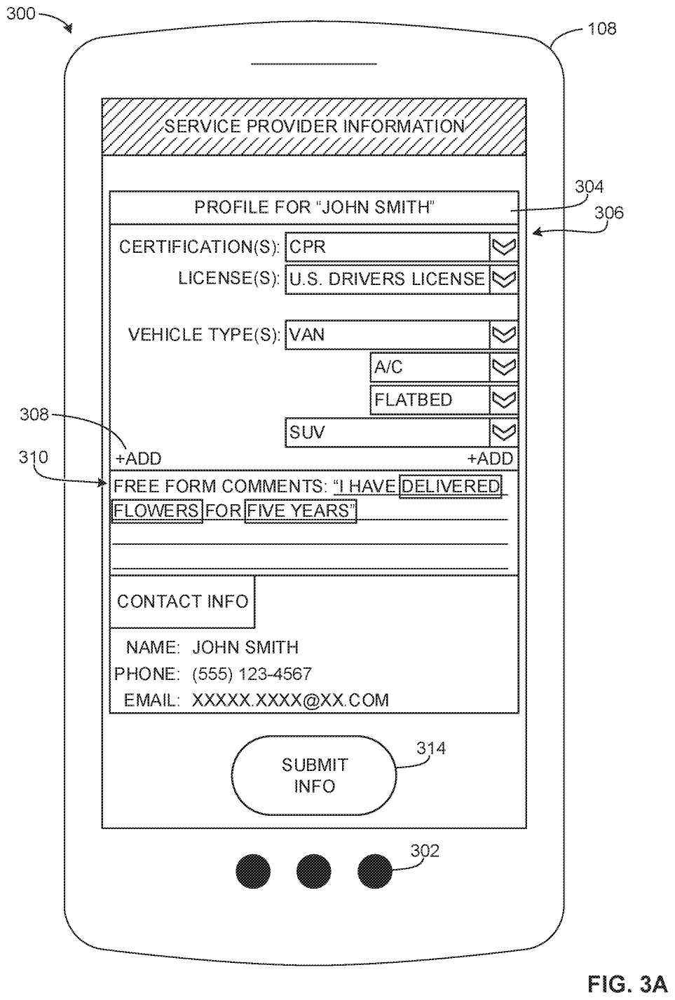

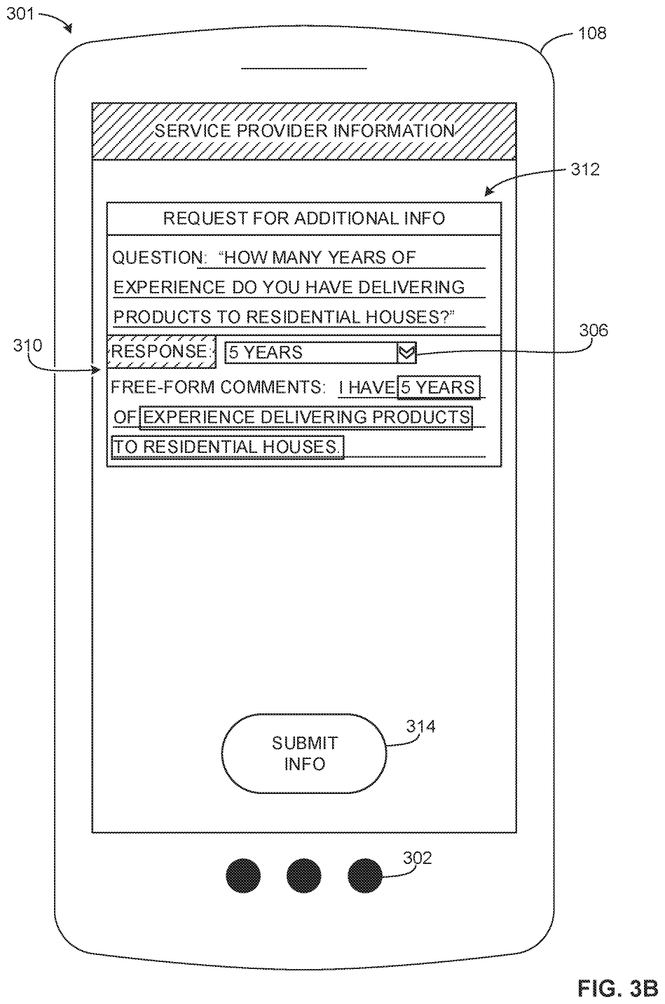

FIGS. 3A and 3B illustrate second example displays 300, 301 of the example GUI 122 of the electronic devices 108 for entering and/or providing the data/information to the central application 104. The second example displays 300, 301 provide for inputs with respect to the service provider information. Service providers 118 can create and/or enter the service provider information by providing one or more inputs using the electronic devices 108 via typing and/or talking. In such examples, each of the electronic devices 108 includes a keyboard (not shown) and/or a microphone 302 that may be integral with the electronic device 108. The entered and/or provided service provider information may be organized in profiles within the central application 104 and that are associated with respective service providers 118. Each of the profiles may include some or all of the service provider information that was entered by the respective service providers 118. For example, a person can enter service provider information such as a profile name 304 (e.g., “John Smith”). In some examples, the example displays 300, 301 include dynamic selection fields (e.g., text boxes, drop-down menus, etc.) 306 of pre-determined credentials, such as certifications, licenses, insurance levels, vehicle types, costs of service, etc., to facilitate selection and/or entry of the credentials. Continuing with the above example, the person representing the service provider interacts with the dynamic selection fields 306 of pre-determined credentials to select pre-determined credentials associated with the person such as, for example, a certification (e.g., a cardiopulmonary resuscitation certification (e.g., indicated via text as “CPR”)), a license (e.g., a government issued driver's license). Additionally, in this example, the person selects pre-determined credentials associated with one or more vehicles owned by the person such as, for example, vehicle types (e.g., a van, an SUV, etc.), vehicle features, (e.g., an air-conditioner and/or heater of the van, a flatbed of the van, etc.), etc.

In some examples, the service providers 118 may increase or decrease a number and/or content of the dynamic selection fields 306 by, for example, selecting text operators or buttons 308. In such examples, the service providers 118 may view lists including pre-determined credentials and can select one or more of the pre-determined credentials of the lists to increase the number and/or content of dynamic selection fields 306 displayed via the second example GUI 122.

In some examples, the displays 300, 301 include a free-form field 310 to enable the service providers 118 to create or enter service provider information via text or audio including natural language phrases. For example, a person may enter natural language phrases such as “I have delivered flowers for 5 years” or “I have delivered flowers to residential homes for 3 years.” In such examples, one or more credentials of the person or service provider may be contained or embedded within the natural language phrases, such as five years of experience for delivering flowers. Additionally or alternatively, in such examples, one or more of the natural language phrases may have a general relevancy to certain service requests and/or requirements of the certain service requests.

Additionally or alternatively, in some examples, the displays 300, 301 include a request or prompt 312 to enable the service providers 118 to create or enter additional service provider information, as shown in the example display 301 of FIG. 3B. The prompt 312 may include first information (e.g., text or audio) that is viewed and/or received by the service providers to enable the service providers 118 to enter or provide second information such as, for example, the additional service provider information via the dynamic selection fields 306 and/or the free-form field 310. In some examples, this first information includes one or more questions corresponding to certain requirements that may be associated with the service requests. In any case, the service providers 118 can submit and/or provide the service provider information and/or the additional service provider information via a selection input to, for example, a submit button 314.

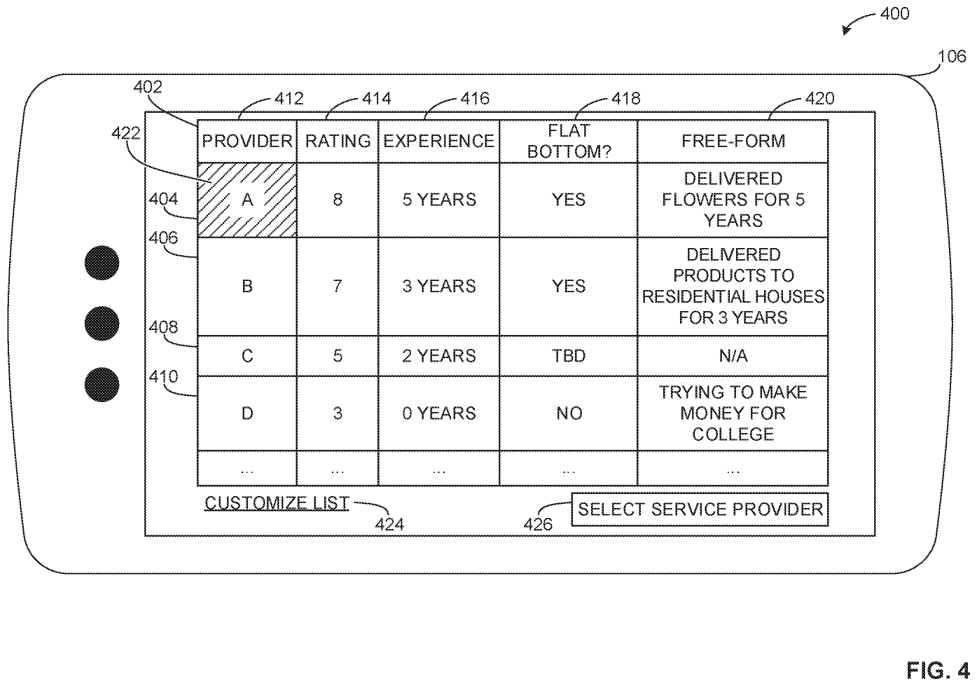

FIG. 4 illustrates a third example display 400 of the example GUI 120 of the electronic devices 106 for entering and/or providing the data/information to the central application 104. The third example display 400 provides for inputs with respect to decisions and/or selections of the customers 116. The third example display 400 may include interactive customer reports 402 to facilitate the decisions and/or selections of the customers 116. In some examples, these interactive customer reports 402 include lists or tables indicating identified suitable service providers 118 and/or profiles of the identified suitable service providers 118. In this example, request information of a service request and service provider information of the identified suitable service providers 118 are listed or organized in a table of the customer report 402. The table includes rows 404, 406, 408, 410 and columns 412, 414, 416, 418, 420 defining cells 422. Each cell 422 may include certain data/information processed by the central application 104, such as requirements of service requests and/or credentials of the service providers 118 that correspond to the requirements. Each cell 422 includes visual indicators (e.g., text, symbols, etc.) corresponding to the data/information contained within each cell 422. In this example, each of the rows 404, 406, 408, 410 corresponds to one of the identified suitable service providers 118 and each of the columns 412, 414, 416, 418, 420 include specific requirements and credentials of the identified service providers 118 that correspond to the specific requirements. In some examples, a number of the rows 404, 406, 408, 410 and/or columns 412, 414, 416, 418, 420 is determined based on a number of the specific requirements. In such examples, a sequence or order of the rows 404, 406, 408, 410 and/or columns 412, 414, 416, 418, 420 including the data/information contained within each cell 422 may be determined based on categories or types of the specific requirements.

In other examples, the sequence or order of the rows 404, 406, 408, 410 and/or columns 412, 414, 416, 418, 420 may be determined based on comparisons performed by the central application 104. In such examples, results of the comparisons (e.g., average ratings or values, weighted ratings or values, etc.) may be included in the cells 422. In other examples, the sequence or order of the rows 404, 406, 408, 410 and/or columns 412, 414, 416, 418, 420 is determined based on settings information provided by the customers 116. In such examples, the customers 116 provide settings information via inputs to the text operators or buttons 424. For example, a customer 116 may provide settings information including ranks for specific requirements to adjust the results of the comparisons and, thus, adjust the sequence. In another example, a customer 116 provides settings information including custom data/information and/or sequences of the rows 404, 406, 408, 410 and/or columns 412, 414, 416, 418, 420.

In this example, the customer 116 has selected the column 412 to include names or identifications of the identified suitable service providers 118. The customer 116 has also selected column 414 to include an average rating (e.g., via the comparisons) of the identified service providers 118, column 416 to include a specific requirement (e.g., 5 years of experience delivering products to residential homes) of their service request and corresponding credentials of the identified service providers, column 418 to include another specific requirement (e.g., a flatbed or bottom of the vehicle) of their service request and corresponding credentials of the identified service providers 118 and/or statuses (e.g., yes, no, pending, etc.) of the credentials and column 418 to include natural language phrases of the identified service providers 118 that correlate and/or are relevant to their service request.

In some examples, the customers 116 may select one or more of the cells 422 in the table 402 that correspond to one of the listed service providers 118 to view additional information of the service provider 118, such as credentials and/or service provider information of the service provider 118 that were not displayed initially in the customer report. In other examples, the customers 116 may select a cell 422 to enable natural language communication (e.g., via instant messaging (IM)) between the customers 116 and the service provider 118 associated with the selected cell 422. Based on a final decision, the customers 116 may select one or more of the listed service providers 118 to provide the service requests by, for example, providing an input to the text operator or button 426.

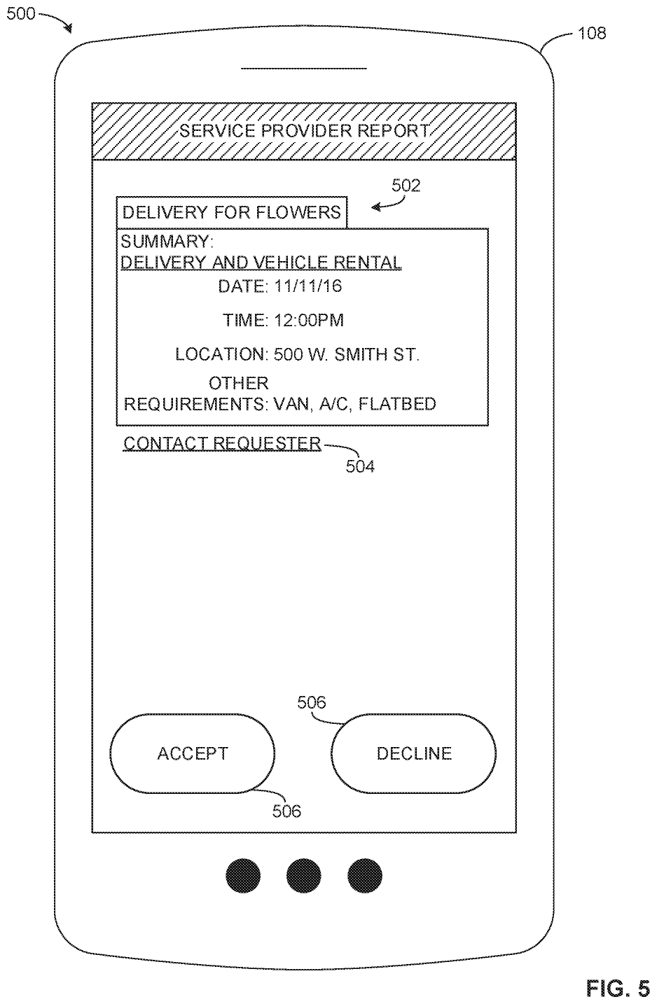

FIG. 5 illustrates a fourth example display 500 of the example GUI 122 of the electronic devices 108 for entering and/or providing the data/information to the central application 104. The fourth example display 500 provides for inputs with respect to decisions and/or selections of the above-described selected service providers 118. The fourth example display 500 may include interactive service provider reports 502 to facilitate the decisions and/or selections of the selected service providers 118. In some examples, these interactive service provider reports 502 include windows that correspond to certain service requests. The windows include request information associated with the service requests, such as names of the service requests, requirements of the service requests, etc. In some examples, the windows include messages (e.g., text or audio) of the customers 116. In other examples, the service provider reports 502 enable natural language communication (e.g., via IM) between the selected service providers 118 and the customers 116 via, for example, selecting a text operator or button 504. Based on a final decision and/or selection, the selected service providers 118 may accept or reject the service requests by, for example, providing an input to an appropriate selection button 506.

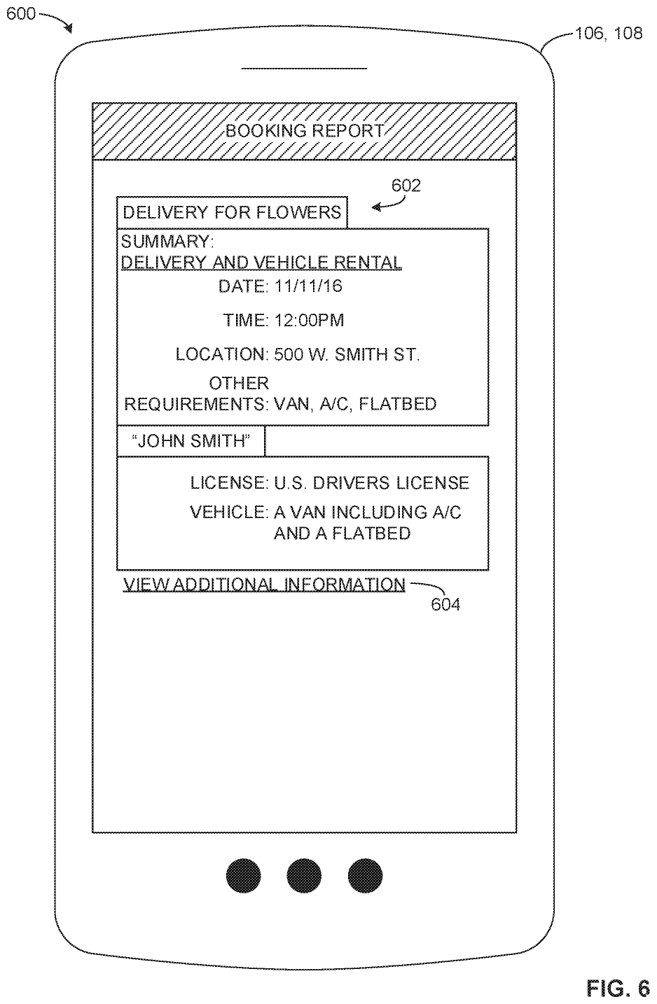

FIG. 6 illustrates another example display 600 of the example GUIs 120, 122 of the electronic devices 106, 108 for entering and/or providing the data/information to the central application 104. The example display 600 provides for inputs with respect to decisions and/or selections of the users. The example display 600 may include booking reports 602 to facilitate the decisions and/or selections of the users. In some examples, these booking reports 602 include windows that correspond to certain service requests and selected service providers 118. These windows may include booking information such as locations, times, dates, contact information and/or, more generally, request information and service provider information associated with a specific service request. In some examples, this booking information enables selected service providers 118 to provide the services of the service request. In other examples, this booking information enables the customers 116 to receive the services.

In some examples, the booking reports 602 enable a secure monetary transaction via a third party service (e.g., PayPal®) between the customers 116 and the selected service providers 118. In other examples, users may select a text operator or button 604 to view additional data/information of the booking reports 602 such as, for example, request information and/or service provider information that was not displayed in the booking reports 602 initially.

The above-described displays 200, 201, 300, 301, 400, 500 and 600 are depicted to display portions of the data/information (e.g., summarized data/information) stored in the database 130. However, the graphic displays 200, 201, 300, 301, 400, 500 and 600 may display additional or all of the data/information stored in the database 130. In such examples, the users may view some or all of the data/information stored in the database 130 by, for example, providing inputs to the GUIs 120, 122 of the electronic devices 106, 108.

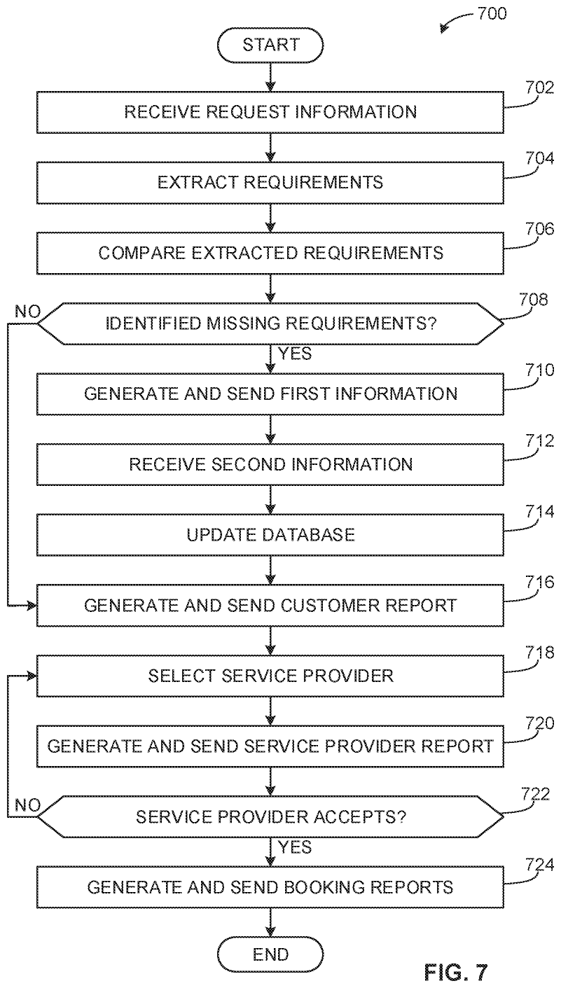

FIG. 7 illustrates a flowchart representative of an example method 700 that can be implemented to automatically provide transportation services to customers requesting the services. The example method 700 can be implemented using the central application 104 and the first and second example GUIs 120, 122 of the electronic devices 106, 108 shown in FIGS. 1A, 1B, 2A, 2B, 3A, 3B, 4, 5 and 6. The example method 700 begins with receiving text and/or audio including request information (block 702) at the first processor 102 that may be associated with service requests initiated by the customers 116. In some examples, request information associated with the service requests can be entered or provided to the communicator 128 by one or more of the customers 116 via the first example GUI 120 of the electronic devices 106 shown in FIGS. 1, 2A and 2B. This request information can be created and/or entered by providing inputs to, for example, dynamic selection fields 206 of pre-determined requirements, search request field 210 and/or other fields displayed via the first example GUI 120. Additionally or alternatively, in some examples, the communicator 128 receives the service requests, request information, text and/or audio from one or more of the resources 124.

The request information is analyzed at block 704 via the request analyzer 132 to, in some examples, extract requirements associated with the service requests. In other examples, the request analyzer 132 extracts conditions or conditional statements associated with the extracted requirements. In such examples, the request analyzer 132 implements fuzzy search and/or fuzzy logic methods to extract requirements and/or conditions that may be contained or embedded within natural language phrases of the received request information. Additionally or alternatively, in such examples, the request analyzer 132 extracts inferred requirements that may satisfy the conditions.

At block 706, the request analyzer 132 compares the extracted requirements associated with the service requests with credentials of the service providers 118 stored in the database 130. In such examples, based on the comparison, requirements are identified that do not correspond to the credentials stored in the database 130. For example, certain identified requirements (e.g., a vehicle including a flatbed, a dimension of the flatbed, etc.) are not mentioned or included in the credentials stored in the database 130 (i.e., the identified requirements are missing).

At block 708, the request analyzer 132 determines, based on the comparison(s) at block 706, if one or more of the extracted requirements are identified as not corresponding to the credentials stored in the database 130. If one or more requirements are determined to be missing and/or non-corresponding to the credentials, control proceeds to block 710, otherwise control proceeds to block 716.

At block 710, the communicator 128 generates and sends first information that may be displayed via the second example GUI 122 of the electronic devices 108. This first information corresponds and/or relates to the identified missing requirements, such as, for example, one or more questions (e.g., text or audio) including the identified missing requirements. In some examples, this first information includes a structure determined by the communicator 128. To determine the structure, the communicator 128 may consider qualities or characteristics of the identified missing requirements. In any case, this first information is generally sent electronically or provided to certain service providers 118 to enable the service providers 118 to interact with the first information. Additionally, the communicator 128 may request a response to the first information, such as an input (e.g., via dynamic selection fields 306 of pre-determined credentials, free-form field 310, etc.) from one or more of the service providers 118. In some examples, the first information may be provided to additional or all service providers 118 in response to determining, for example, a particular number (e.g., a number above a threshold number) of the service providers that have the non-corresponding credentials via the request analyzer 132.

In response to the first information generated and sent at block 710, the communicator 128 receives second information (block 712) associated with and/or corresponding to the service providers 118. In some examples, this second information includes additional service provider information, such as additional credentials that may correspond to one or more of the identified requirements. In such examples, the service providers may provide the second information via the second example GUI 122 of the electronic devices 108. In other examples, this second information includes crowd-sourced information, such as crowd-sourced ratings of one or more of the service providers 118. Additionally or alternatively, in some examples, the communicator 128 receives this second information from one or more of the resources 124.

At block 714, the communicator 128 updates the database 130 with the first information and/or the second information. In some examples, the request analyzer 132 processes and/or analyzes the second information to identify and/or extract additional credentials (e.g., contained or embedded within natural language phrases) from the second information. In such examples, the communicator 128 updates the database 130 with the additional credentials. In other examples, the communicator 128 updates the dynamic selection fields 306 of pre-determined credentials with the additional credentials.

At block 716, interactive customer reports 402 are generated via the communicator 128 and sent electronically or provided to the customers 116. These interactive customer reports 402 include interactive lists of service provider information and/or profiles associated with the service providers 118. In some examples, the customer reports 402 are formatted based on comparisons (e.g., via the request analyzer 132) of certain requirements with certain credentials stored in the database 130. In other examples, the customers 116 input and/or provide settings information to format or customize the customer reports 402. In such example, the communicator 128 organizes or formats the customer reports 402 based on the comparisons and/or the settings information. In some examples, the communicator 128 enables the customers 116 to communicate (e.g., via IM) with the service providers 118. In any case, based on a final decision and/or selection of the customers 116, the communicator 128 selects one or more of the listed service providers 118 at block 718.

At block 720, a service provider report 502 is generated via the communicator 128 and sent electronically or provided to the selected service provider(s) 118. The selected service provider(s) 118 may interact with the service provider report 502 to accept or reject a specific service request. In some examples, the communicator 128 enables the selected service provider(s) 118 to communicate (e.g., via IM) with a customer 116 of the specific service request.

At block 722, the communicator 128 determines whether the specific service request is accepted or rejected by the selected service provider(s) 118. If the specific service request is determined to be rejected by the selected service provider(s) 118, the communicator 128 removes the selected service provider(s) 118 from the customer report of the specific service request and control returns to block 718, otherwise control proceeds to block 724.

At block 724, the communicator 128 generates booking reports 602 associated with an accepted service request. These booking reports 602 are sent electronically or provided to the customer 116 of the accepted service request and to the selected service provider(s) 118. In some examples, the booking reports 602 include request information of the accepted service request, credentials of the selected service provider(s) 118 and/or, more generally, data/information that is necessary to enable the customer 116 to receive the requested service and/or to enable the selected service provider(s) 118 to perform or provide the requested services.

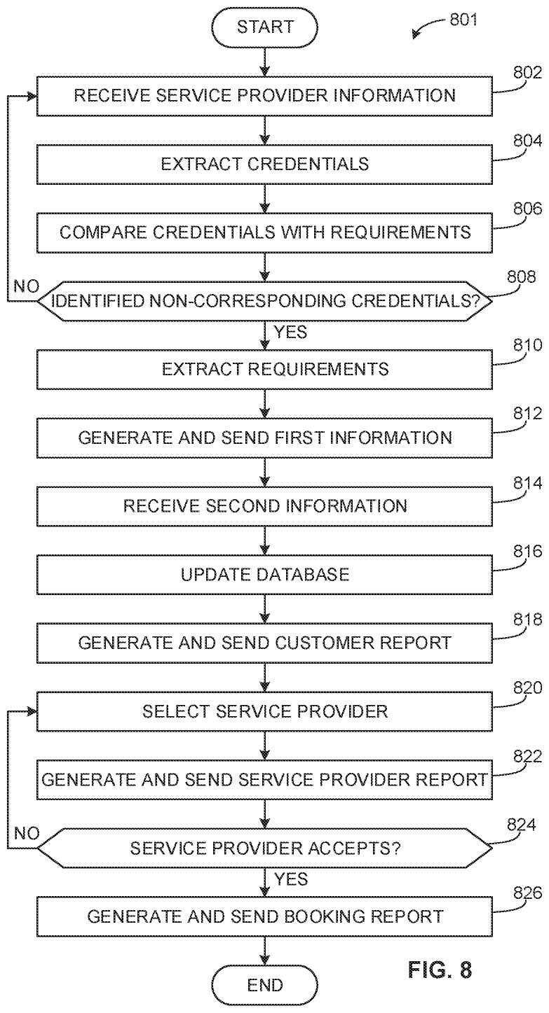

FIG. 8 illustrates a flowchart representative of another example method 800 that can be implemented using the central application 104 and the first and second example GUIs 120, 122 of the electronic devices 106, 108 shown in FIGS. 1A, 1B, 2A, 2B, 3A, 3B, 4, 5 and 6. The example method 800 begins with receiving service provider information (block 802) that is associated with the service providers 118. In some examples, the service provider information can be entered or provided to the communicator 128 by one or more of the service providers 118 via the second example GUI 122 of the electronic devices 108 shown in FIGS. 1, 3A and 3B. This service provider information can be created and/or entered by providing inputs to, for example, the dynamic selection fields 306 of pre-determined credentials, the free-form field 310 and/or other fields displayed via the second example GUI 122. Additionally or alternatively, in some examples, the communicator 128 receives service provider information from one or more of the resources 124.

The service provider information is analyzed at block 804 via the request analyzer 132 to extract credentials associated with the service providers and/or associated with driving services that may be needed and/or required by the customers 118. In such examples, the request analyzer 132 implements fuzzy search and/or fuzzy logic methods to extract credentials that may be contained or embedded within natural language phrases of the received service provider information.

At block 806, the request analyzer 132 compares the extracted credentials associated with the service providers 118 with requirements associated with driving services stored in the database 130. In such examples, the request analyzer 132 identifies credentials that do not correspond to the requirements stored in the database 130. For example, certain extracted credentials (e.g., experience performing unique driving services, unique features of a vehicle, etc.) are not mentioned or included in the requirements stored in the database 130.

At block 808, the request analyzer 132 determines, based on the comparison(s) at block 806, if one or more of the extracted credentials are identified as missing and/or not corresponding to the requirements stored in the database 130. If one or more credentials are determined to be missing and/or non-corresponding, control proceeds to block 810, otherwise control returns to block 802.

At block 810, the request analyzer 132 processes the one or more non-corresponding credentials to determine, identify and/or extract one or more requirements. In some examples, these identified and/or extracted requirements are not stored in the database 130 and/or do not correspond to the requirements stored in the database 130. In such examples, the request analyzer 132 may implement pattern recognition methods and/or techniques (e.g., supervised classification, unsupervised classification, etc.) to determine, identify, and/or extract the requirements based on the one or more identified non-corresponding credentials.

At block 812, the communicator 128 generates and sends first information that may be displayed via the second example GUI 122 of the electronic devices 108. This first information corresponds and/or relates to the one or more identified and/or extracted requirements, such as, for example, one or more questions including the identified and/or extracted requirements. In some examples, this first information includes a structure determined by the communicator 128. To determine the structure, the communicator 128 may consider qualities or characteristics of the identified requirements. In any case, this first information is generally sent electronically or provided to the service providers 118 having the identified credentials to enable the service providers 118 to interact with the first information. Additionally, the communicator 128 may request a response to the first information, such as an input (e.g., via the dynamic selection fields 306 of pre-determined credentials, the free-form field 310, etc.) from one or more of the service providers 118. In some examples, the first information may be sent to additional or all service providers in response to determining, for example, a particular number (e.g., a number above a threshold number) of the identified service providers having the identified credentials.

In response to the first information generated and sent at block 812, the communicator 128 receives second information (block 814) associated with and/or corresponding to the service providers 118. In some examples, this second information includes additional service provider information, such as additional credentials that may correspond to one or more of the identified requirements. In such examples, the service providers may provide the second information via the second example GUI 122 of the electronic devices 108. Additionally or alternatively, in some examples, the communicator 128 receives this second information from one or more of the resources 124.

At block 816, the communicator 128 updates the database 130 with the first information and/or the second information. In some examples, the communicator 128 updates the dynamic selection fields 306 with the first and/or second information. In other examples, the request analyzer 132 processes and/or analyzes the second information to determine and/or extract additional credentials (e.g., contained or embedded within natural language phrases) from the second information.

At block 818, the interactive customer reports 402 are generated via the communicator 128 and sent electronically or provided to customers 116 initiating service requests corresponding to one or more of the first information and/or second information. These interactive customer reports 402 include interactive lists of service provider information and/or profiles associated with identified suitable and/or candidate service providers 118. In some examples, the customer reports 402 are formatted based on comparisons, via the request analyzer 132, of certain requirements with certain credentials stored in the database 130. In other examples, the customers 116 input and/or provide settings information to format or customize the customer reports 402. In such example, the communicator 128 organizes or formats the customer reports 402 based on the comparisons and/or the settings information. In some examples, the communicator 128 enables the customers 116 to communicate (e.g., via IM) with the service providers 118. In any case, based on a final decision and/or selection of the customers 116, the communicator 128 selects one or more of the listed service providers 118 at block 820.

At block 822, a service provider report 502 is generated via the communicator 128 and sent electronically or provided to the selected service provider(s) 118. The selected service provider(s) 118 may interact with the service provider report 502 to accept or reject a specific service request. In some examples, the communicator 128 enables the selected service provider(s) 118 to communicate (e.g., via IM) with a customer 116 of the specific service request.

At block 824, the communicator 128 determines whether the specific service request is accepted or rejected by the selected service provider(s) 118. If the specific service request is determined to be rejected by the selected service provider(s) 118, the communicator 128 removes the selected service provider(s) 118 from the customer report of the specific service request and control returns to block 820, otherwise control proceeds to block 826.

At block 826, the communicator 128 generates the booking reports 602 associated with an accepted service request. These booking reports 602 are sent electronically or provided to the customer 116 of the accepted service request and to the selected service provider(s) 118. In some examples, the booking reports 602 include request information of the accepted service request, credentials of the selected service provider(s) 118 and/or, more generally, data/information that is necessary to enable the customer 116 to receive the requested service and/or to enable the selected service provider(s) 118 to perform or provide the requested services.

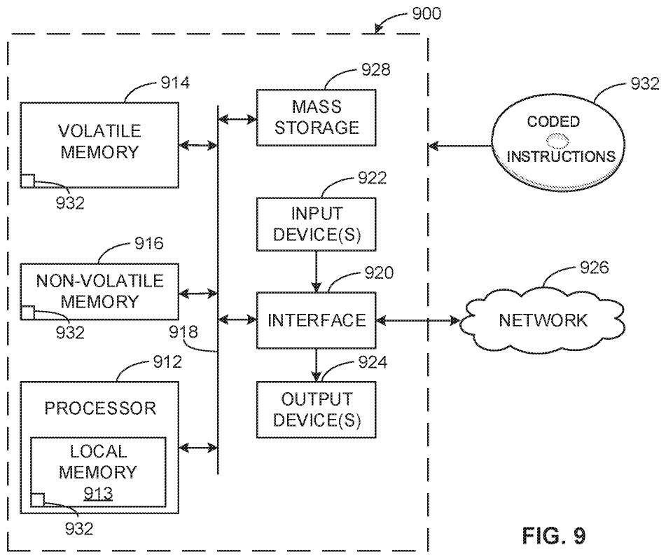

The flowcharts of FIGS. 7 and 8 are representative of example methods 700, 800 that may be used to implement the example system 100 of FIGS. 1A and 1B. The methods 700, 800 may be implemented using machine-readable instructions that comprise a program for execution by a processor such as the processor 902 shown in the example processor platform 900, discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 902, but the entire program and/or parts thereof could alternatively be executed by a device other than the processor 902 and/or embodied in firmware or dedicated hardware. Further, although the example program is described with reference to the flowcharts illustrated in FIGS. 7 and 8, many other methods of implementing the example system 100 may alternatively be used. For example, the order of execution of the blocks may be changed, and/or some of the blocks described may be changed, eliminated, or combined.

As mentioned above, the example processes of FIGS. 7 and 8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7 and 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 9 is a block diagram of an example processor platform 900 capable of executing instructions to implement the methods 700, 800 and the example system 100 of FIGS. 1A and 1B. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

Coded instructions 932 to implement the method 700 of FIG. 7 may be stored in the mass storage device 928, in the volatile memory 914, in the non-volatile memory 916, and/or on a removable tangible computer readable storage medium such as a CD or DVD.

From the foregoing, it will be appreciated that the above disclosed systems, methods, and apparatus dynamically provide customers with transportation services. The disclosed examples provide customers with transportation related services that would otherwise not have been provided. The disclosed examples determine and/or extract requirements from request information associated with service requests of customers. The disclosed examples extract credentials from service provider information associated with service providers. The disclosed examples identify and/or extract requirements of the service requests that do not correspond to the extracted credentials. The disclosed examples identify and/or extract requirements that do not correspond to requirements stored in a database. The disclosed examples generate first information related to the identified and/or extracted requirements and receive second information related to the service providers. The disclosed examples update the database with the first information and/or the second information.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a request analyzer to:
extract, from a natural language phrase of text or audio provided by a person, requirements associated with a driving service, the person to receive the driving service;
compare the requirements to first credentials associated with service providers to provide the driving service, the first credentials stored in a database;
identify, based on the comparison, one or more of the requirements that do not correspond to the first credentials; and
a communicator to:
request from the service providers, first information relating to the identified one or more requirements;
receive second information in response to the request for the first information, the second information including second credentials relating to the identified one or more requirements; and
update the database with the first or second information.

2. The apparatus of claim 1, wherein the communicator is further to update dynamic selection fields with the first or second information, the dynamic selection fields to facilitate selections of the person or the service providers.

3. The apparatus of claim 1, wherein the communicator is further to electronically send a report to the person, the report formatted based on the requirements and including the second information and profiles for the service providers that provided the second information.

4. The apparatus of claim 3, wherein the communicator is further to select, based on an input from the customer, one or more of the service providers listed in the report to provide the driving service.

5. The apparatus of claim 4, wherein the communicator is further to electronically send a booking report to the person and to one or more of the selected service providers to enable the one or more selected service providers to provide the driving service.

6. The apparatus of claim 5, wherein the second information includes one or more natural language phrases provided by one or more of the service providers.

7. The apparatus of claim 6, wherein the analyzer is further to extract the second credentials from the one or more natural language phrases.

8. The apparatus of claim 1, wherein the communicator is to further receive the text, audio or second information from one or more resources.

9. A method comprising:
extracting from natural language phrases of text or audio provided by service providers, first credentials associated with driving services, the service providers to perform the driving services;
comparing, via a processor, the first credentials with first requirements stored in a database, the first requirements associated with the driving services;
extracting, via the processor and based on the comparison, a second requirement that is not stored in the database;
requesting from the service providers, first information relating to the second requirement;
receiving second information in response to the request for the first information, the second information including second credentials relating to the second requirement; and
updating the database with the first or second information.

10. The method of claim 9, further including updating dynamic selection fields with the first information or second information, the dynamic selection fields to facilitate selections of a person or the service providers, the person to receive a driving service associated with the second requirement.

11. The method of claim 9, further including electronically sending a report to a person to receive a driving service associated with the second requirement, the report including listed profiles for the service providers that provided the second information.

12. The method of claim 11, further including electronically sending a booking report to the person and to one or more service providers listed in the report to enable the one or more listed service providers to provide the driving service.

13. The method of claim 9, wherein the second information includes one or more natural language phrases provided by one or more of the service providers.

14. The method of claim 13, further including extracting the second credentials from the one or more natural language phrases.

15. The method of claim 9, further including receiving the text, audio or second information from one or more resources.

16. A tangible machine-readable storage medium comprising instructions which, when executed, cause a processor to:
extract, from a natural language phrase of text or audio provided by a person, requirements associated with a driving service, the person to receive the driving service;
compare the requirements to first credentials associated with service providers to provide the driving service, the first credentials stored in a database;
identify, based on the comparison, one or more of the requirements that do not correspond to the first credentials;
request from the service providers, first information relating to the identified one or more requirements;
receive second information in response to the request for the first information, the second information including second credentials relating to the identified one or more requirements; and
update the database with the first or second information.

17. The tangible machine-readable storage medium of claim 16, further causing the processor to electronically send a report to the person, the report formatted based on the requirements and including the second information and profiles for the service providers that provided the second information.

18. The tangible machine-readable storage medium of claim 17, further causing the processor to electronically send a booking report to the person and to one or more of the service providers listed in the report to enable the one or more listed service providers to provide the driving service.

19. The tangible machine-readable storage medium of claim 16, wherein the second information includes one or more natural language phrases provided by one or more of the service providers.

20. The tangible machine-readable storage medium of claim 19, further causing the processor to extract the second credentials from the one or more natural language phrases provided by one or more of the service providers.
